(19) United States
(12) Patent Application Publication
(10) Pub. No.: US 2002/0003784 A1
(43) Pub. Date: Jan. 10, 2002

(54) Handover control method and mobile station unit to implement the method

(75) Inventors: Katsuteru Okabe, Yokohama-shi (JP); Koichiro Togao, Yokohama-shi (JP)

Correspondence Address: PEARNE & GORDON LLP, 526 SUPERIOR AVENUE EAST, SUITE 1200, CLEVELAND, OH, 44114-1484, US

(73) Assignee: Matsushita Electric Industrial Co., Ltd.

(21) Appl. No.: 09/878,116

(22) Filed: Jun. 8, 2001

(30) Foreign Application Priority Data
Jun. 9, 2000 (JP) P. 2000-173998

(51) Int. Cl. H04Q 7/20

(52) U.S. Cl. 370/331; 370/337; 370/350; 455/439

(57) ABSTRACT

In case two slots among the communications slots 0 through 7 in a time-division-multiplexed frame is used and the receiving field level of a communications signal from the first base station 1 has dropped below a predetermined reference value while data transmission/reception is in progress, retrieval of an announcement signal from another base station in the remaining idle slots is started. A link channel is established to a candidate base station and processing from TCH synchronization to CONNECT reception is performed while communications with the first base station 1 is maintained. On receiving CONNECT (speed enable signal), communications with the first base station is halted and data transmission/reception to/from the candidate base station is started to perform voice or data communications and complete a handover. Thus, it is provided a handover control method whereby the mute time in a handover during communications is minimized to continue conversation seamlessly.

The present invention relates to a handover control method and a mobile station unit using the method.

In the related art, as shown in the first related art in FIG. 4, in case degradation of receiving quality of the channel used for communications is detected, the carrier is changed from Tch (communication channel) to Cch (control channel) and communications with the base station are halted. Handover control is known that retrieval of a handover-to base station is started, and when the control signal with a high receiving field level is detected, a channel is established to the base station and communication channel (TcH) synchronization is made, followed by communications to complete handover.

Or, as shown in the second related art example in FIG. 5, handover control is known that a handover-to candidate base station is retrieved while communicating with the first base station 1, and after communications with the first base station are terminated when speech quality degrading is detected, communication channel TcH synchronization is made with the handover-to base station and communications are started to complete handover.

However, the handover control via the first related art example, retrieval of a handover-to base station is started, handover-to base station is located, and a channel is established to the base station to start communications. This involves a problem that a long mute time takes place during communications.

On the other hand, handover control in the second related art example improves the problem and reduces the mute time during communications below the first related art example. The second approach, however, has a problem that communications are terminated when a link channel is established and the mute time is inevitably caused during handover processing such as communication channel TcH synchronization and sound is audibly interrupted for a short time of about 500 ms.

### SUMMARY OF THE INVENTION

The invention solves the problem and aims at providing an excellent handover control method whereby the mute tome caused by a handover is further reduced to avoid audible sound interruption.

The invention, in order to attain the object, retrieves an announcement signal from another base station in idle slots where communications are not performed in case the receiving level has dropped below a predetermined level during communications with the first base station, establishes a channel with the second base station as a handover destination, waits for a speech enable signal while communicating with the first base station, disconnects communications with the first base station on receiving the speech enable signal, and starts communications with the handover-to base station.

In the handover control according to the first related art example, communications are halted, a handover-to base station is retrieved, a link channel is established, and a speech enable signal is received. In the handover control according to the second related art example, communications are terminated on establishment of a link channel then only communication channel TcH synchronization is made. According to the invention, a handover-to base station is retrieved in a slot other than the communications slots, a link channel is established, and a speech enable signal is received. This reduces the communications halt time to a minimum of several milliseconds.

### BRIEF DESCRIPTION OF THE DRAWINGS

FIGS. 1A to 1E show the state transition of a communications slot between a base station and a mobile station in order to explain the high-speed handover control method in the first embodiment of the invention;

FIG. 2 shows the concept of handover operation in the first embodiment of the invention;

FIG. 3 shows a flowchart to explain handover operation in the second embodiment of the invention;

FIG. 4 shows the concept of handover operation in the first related art example; and

FIG. 5 shows the concept of handover operation in the second related art example.

### DETAILED DESCRIPTION OF THE PREFERRED EMBODIMENTS

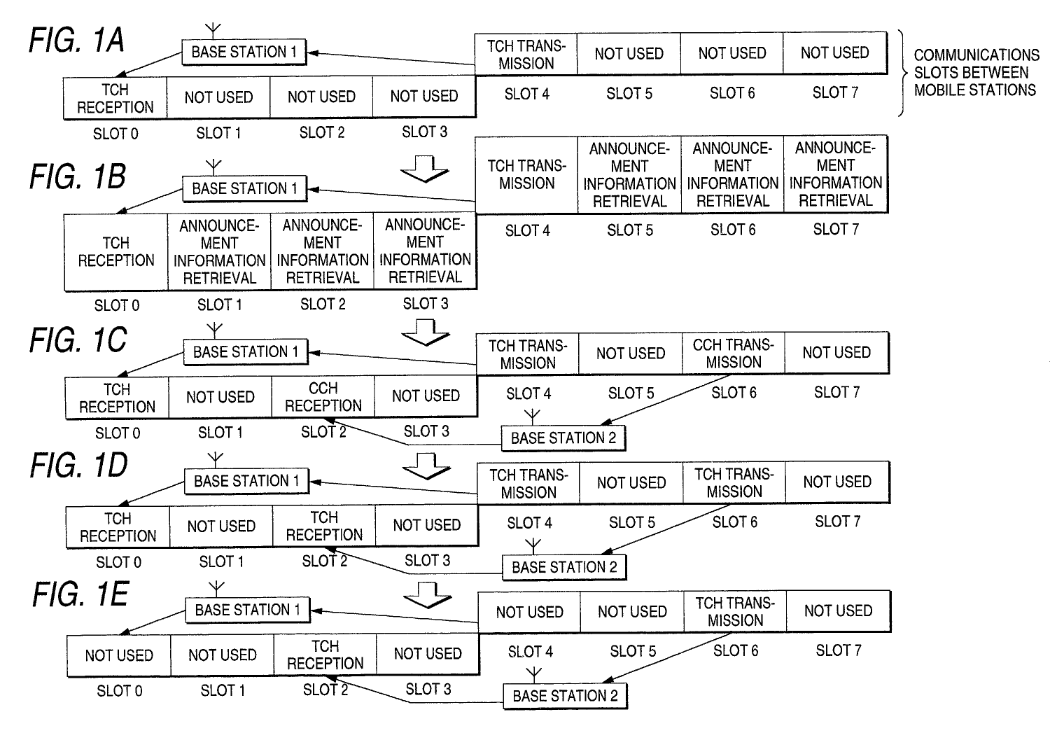

Embodiments of the invention will be described referring to FIGS. 1 through 3.

First Embodiment

FIGS. 1A to 1E show the state transition of a communications slot between a base station and a mobile station in PHS mobile communications in order to explain the high-speed handover control method in the first embodiment of the invention.

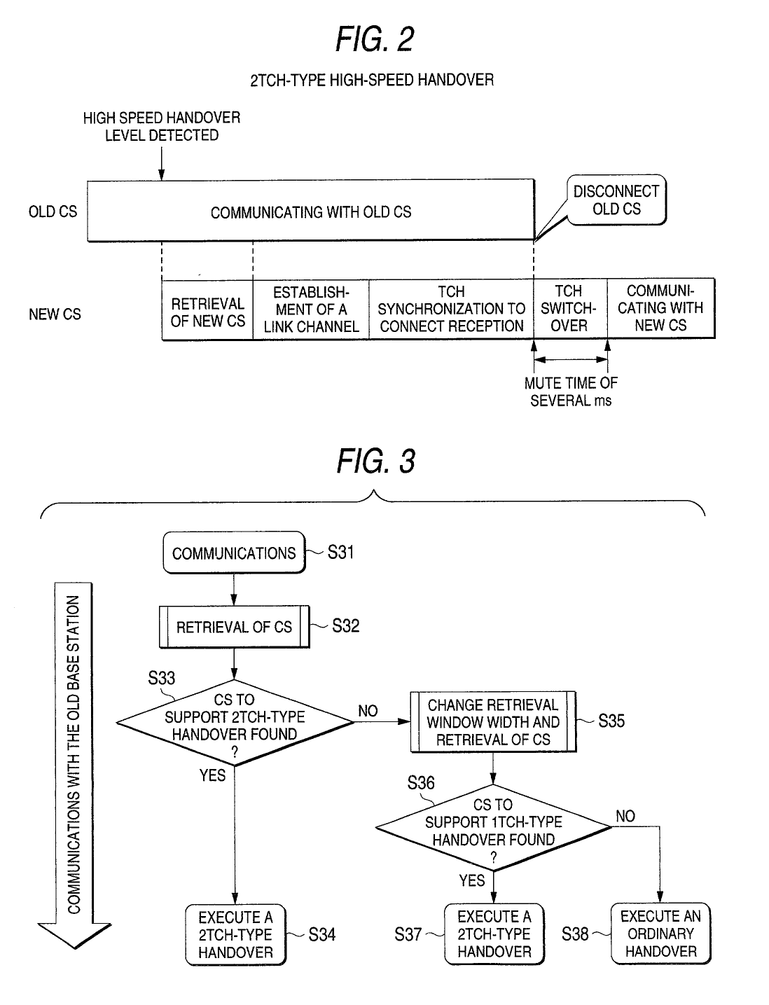

FIG. 2 shows the concept of handover operation in the first embodiment of the invention.

FIG. 1A shows the ordinary communications state. Communications are performed with the first base station using two slots among the communications slots 0 through 7 in a time-division-multiplexed frame. In case the receiving field level of a communications signal (Tch) from the first base station 1 has dropped below a high-speed handover processing level, retrieval of an announcement signal is started from another base station in idle slots other than the slots where communications are performed, as shown in FIG. 1B. In case an announcement signal (Cch) above the handover destination selection level is found as shown in FIG. 1C, a link channel (LcH) is established to a base station (hereinafter referred to as the second base station) 2 transmitting the announcement signal (Cch), and performs communication channel TcH synchronization and receives CONNECT (speech enable signal) as shown in FIG. 1D. Communications with the first base station is maintained.

As shown in FIG. 1D, on receiving CONNECT (speech enable signal), communications with the first base station 1 is halted and control make transition to communications with the second base station 2 shown in FIG. 1E to complete a high-speed handover.

According to the first embodiment of the invention, control proceeds to reception of CONNECT (speech enable signal) from the second base station 2 while performing communications with the first base station 1. As shown in FIG. 2, it is possible to reduce the mute time that has taken place during a handover by the time required for retrieval of a handover-to base station, establishment of a link channel, communication channel TcH synchronization and CONNECT reception thus providing a mute time of several milliseconds. This prevents audible sound interruption.

Second Embodiment

FIG. 3 shows a flowchart to explain handover operation in the second embodiment of the invention.

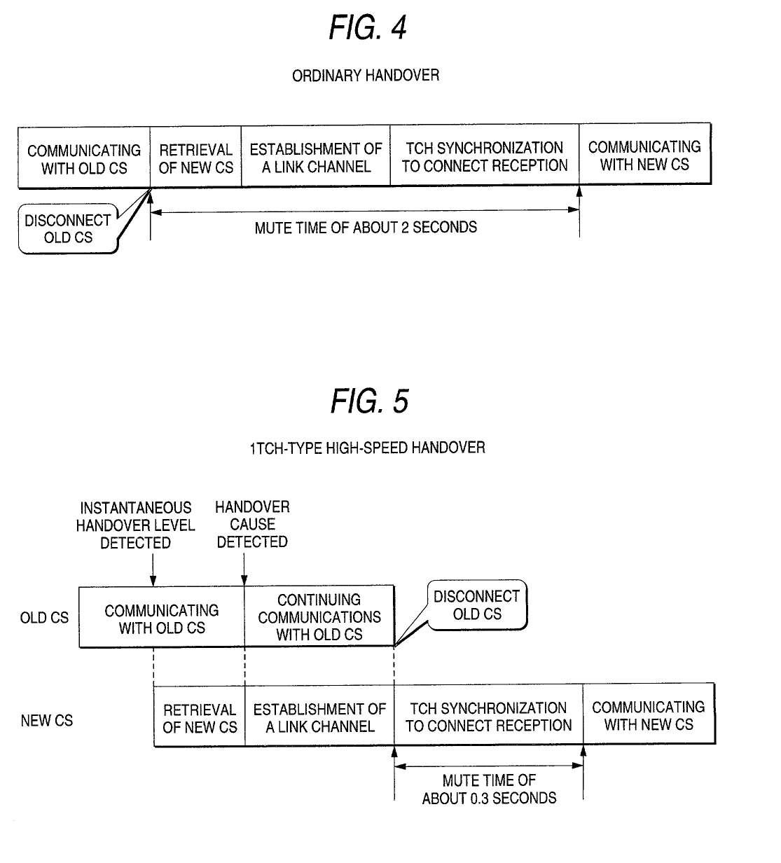

As shown in FIG. 3, during communications (Step 31), when the receiving field level of the first base station 1 has dropped below the high-speed handover processing level, a handover-to base station is retrieved with which the mobile station can perform processing from communication channel TcH synchronization to CONNECT reception while communicating with the first base station 1 (Step 32). In case an appropriate base station is not retrieved in Step 33, a base station is retrieved with which the mobile station can proceed up to establishment of a link channel while communicating with the first base station 1, by broadening a retrieval window width as similar manner shown in the second related art example of FIG. 5 (Steps 35, 36). In case the retrieval has failed, communications are disconnected by using the approach shown in the first related art example of FIG. 4 and a handover with a longer mute time to perform retrieval of a handover-to base station (Step 38).

By carrying out a sequence to perform a handover with a short mute time in a higher priority order, the mute section during communication is reduced thus upgrading the speech quality.

While the two aforementioned embodiments show cases where the receiving field level has dropped during communications, the same processing as the in the embodiments may be performed in case speech quality is degraded due to degradation of FER (error rate), handover instruction from the base station or slot error.

While the two embodiments shows case where a single channel is used for signal transmission/reception, the same processing as the in the embodiments may be performed in case degradation of speech quality is detected during signal transmission/reception in a plurality of channels.

While the figures of the two embodiment assumes speech slots to the first base station as Slots 0 and 4 and speech slots to a handover-to base station as Slots 2 and 6, and slots may be used for communications.

As mentioned earlier, the invention retrieves an announcement signal from another base station in idle slots other than the slots used for communications in case switchover is made between base stations in mobile communications, establishes a channel with the second base station as a handover destination, and receives a speech enable signal while communicating with the first base station, then halts communications with the first base station on receiving the speech enable signal, and starts communications with the handover-to base station (second base station) to complete a handover. This control has an advantage of reducing the mute time during a handover to a minimum of several milliseconds.

What is claimed is:

1. A handover control method for a mobile station unit communicating with a first base station, said handover control method comprising the steps of:
retrieving an announcement signal from another base station in idle slots other than a slots used for communications with the first base station in case the receiving level has dropped below a predetermined level, the slots defined in a time-division-multiplexed frame;
establishing a channel with a second base station as a handover destination detected, and performing reception of a speed enable signal while communicating with the first base station;
disconnecting communications with the first base station on receiving the speech enable signal; and
starting communications with said second base station.

2. A handover control method comprising the steps of:
retrieving a handover-to base station with which the mobile station can perform processing up to communication channel (Tch) synchronization while communicating with the handover-from base station;
performs handover processing in case such a base station is present, and retrieving a base station with which the mobile station can perform processing up to establishment of a link channel in case it is absent; and
disconnecting communications with the current base station and performing handover processing in case it is present, and performing ordinary handover processing with a longer mute time in case it is absent.

3. A mobile station unit that is able to use a plurality of slots simultaneously to transmit and receive control signal and speech signal data, in the mobile station unit it is implemented a handover control method comprising the steps of:
retrieving an announcement signal from another base station in idle slots other than a slots used for communications with the first base station in case the receiving level has dropped below a predetermined level, the slots defined in a time-division-multiplexed frame;
establishing a channel with a second base station as a handover destination detected, and performing reception of a speed enable signal while communicating with the first base station;
disconnecting communications with the first base station on receiving the speech enable signal; and
starting communications with said second base station.

4. A mobile station unit that is able to use a plurality of slots simultaneously to transmit and receive control signal and speech signal data, in the mobile station unit it is implemented a handover control method comprising the steps of:
retrieving a handover-to base station with which the mobile station can perform processing up to communication channel (Tch) synchronization while communicating with the handover-from base station;
performs handover processing in case such a base station is present, and retrieving a base station with which the mobile station can perform processing up to establishment of a link channel in case it is absent; and
disconnecting communications with the current base station and performing handover processing in case it is present, and performing ordinary handover processing with a longer mute time in case it is absent.

5. A mobile station unit in that the width of the retrieval window to retrieve a handover-to base station is variable, in the mobile station unit it is implemented a handover control method comprising the steps of:
retrieving a handover-to base station with which the mobile station can perform processing up to communication channel (Tch) synchronization while communicating with the handover-from base station;
performs handover processing in case such a base station is present, and retrieving a base station with which the mobile station can perform processing up to establishment of a link channel in case it is absent; and
disconnecting communications with the current base station and performing handover processing in case it is present, and performing ordinary handover processing with a longer mute time in case it is absent.
